(19) United States
(12) Patent Application Publication
(10) Pub. No.: US 2026/0321750 A1
(43) Pub. Date: Oct. 15, 2026

(54) Rechargeable Battery Pack for Supplying Electrical Drive Power to an Electrically Driven Piece of Work Equipment, and System Comprising the Rechargeable Battery Pack

(71) Applicant: Andreas Stihl AG & Co. KG, Waiblingen (DE)

(72) Inventors: Radu BARZA, Waiblingen (DE); Nils FREY, Stuttgart (DE); Dominik BARTLE, Kernen (DE); Friedhelm KOCH, Allmersbach im Tal (DE)

(21) Appl. No.: 19/644,025

(22) Filed: Apr. 10, 2026

(30) Foreign Application Priority Data
Apr. 11, 2025 (DE) 10 2025 114 349.8

(51) Int. Cl. H01M 10/42; H01M 10/48; H01M 50/213; H01M 50/247; H01M 50/583

(52) U.S. Cl. CPC H01M 10/425; H01M 10/482; H01M 50/213; H01M 50/247; H01M 50/583; H01M 2010/4271; H01M 2200/103; H01M 2220/30

(57) ABSTRACT

A rechargeable battery pack supplies electrical drive power to an electrically driven piece of work equipment. The rechargeable battery pack has an, in particular cuboid, cell block, a battery management system and an FPC connector. The cell block has rechargeable battery cells. The battery management system is designed to detect electrical measurement signals, in particular cell voltages, of the rechargeable battery cells. The FPC connector has electrical measurement conductor paths, wherein the measurement conductor paths provide electrical measurement connections of the battery management system to the rechargeable battery cells. The measurement conductor paths are designed to transmit the measurement signals. The FPC connector has electrical overcurrent protection fuses which are designed to interrupt the measurement conductor paths, in particular in each case, to protect the battery management system against an electrical overcurrent. The FPC connector extends at least on a first block circumferential side of the cell block over more than 50%, in particular over 100%, of a distance from a first end of the block circumferential side, which adjoins a first block front side of the cell block, to a second end of the block circumferential side, which adjoins a second block front side of the cell block, wherein the second block front side is located opposite the first block front side.

### CROSS REFERENCE TO RELATED APPLICATION

This application claims priority under 35 U.S.C. § 119 from German Patent Application No. 10 2025 114 349.8, filed Apr. 11, 2025, the entire disclosure of which is herein expressly incorporated by reference.

### FIELD OF APPLICATION

The invention relates to a rechargeable battery pack for supplying electrical drive power to an electrically driven piece of work equipment and to a system comprising the rechargeable battery pack.

### PROBLEM AND SOLUTION

The invention is based on the object of providing a rechargeable battery pack for supplying electrical drive power to an electrically driven piece of work equipment, and a system comprising the rechargeable battery pack which, in particular each of which, have improved properties.

The invention solves this problem by providing a rechargeable battery pack as described in the independent claim. Advantageous developments and embodiments of the invention are described in the dependent claims.

The rechargeable battery pack according to the invention is designed, in particular, to supply electrical drive power to an electrically driven piece of work equipment. The battery pack comprises an, in particular, cuboid, cell block, a battery management system and an FPC connector. The cell block comprises the rechargeable battery cells. The battery management system is designed to detect electrical measurement signals, in particular cell voltages, of the rechargeable battery cells. The FPC connector comprises at least electrical measurement conductor paths. At least the measurement conductor paths provide at least electrical measurement connections of the battery management system to the rechargeable battery cells, in particular a measurement connection of the measurement connections of the battery management system to each rechargeable battery cell of the rechargeable battery cells. At least the measurement conductor paths are designed to transmit at least the measurement signals, in particular to detect the measurement signals. In other words: By means of at least the measuring conductor paths, the battery management system and the rechargeable battery cells comprise at least the measurement connections to one another for transmission of at least the measurement signals. The FPC connector comprises electrical overcurrent protection fuses. The overcurrent protection fuses are designed to interrupt at least the measurement conductor paths or the measurement connections, in particular in each case and/or to interrupt the transmission at least of the measurement signals, to protect the battery management system, and in particular therefore the rechargeable battery pack and/or the rechargeable battery cells, against an electrical overcurrent. The FPC connector, in particular by way of at least the measurement conductor paths, at least on a first block circumferential side of the cell block extends over more than 50% (percent), in particular over at least 75%, in particular over 100%, of an extent from a first end of the block circumferential side to a second end of the block circumferential side. The block circumferential side or the first end adjoins a first block front side of the cell block. The block circumferential side or the second end adjoins a second block front side of the cell block. The second block front side is located opposite the first block front side.

This enables, in particular, the overcurrent protection fuses enable, interception of at least one short circuit caused by a manufacturing or production fault and/or contamination, in particular wherein at least one measurement conductor path of the measurement conductor paths or at least one measurement connection of the measurement connections may not be at a ground reference potential. In addition or as an alternative, this, in particular the protection against overcurrent, enables prevention of uncontrolled heat generation or development. Again in addition or as an alternative, this, in particular this type of protection against overcurrent, enables the rechargeable battery pack to be diagnosed, in particular by the piece of work equipment. Again in addition or alternatively, this, in particular the fact that the FPC connector comprises the overcurrent protection fuses, enables a space-saving design of the rechargeable battery pack. Again in addition or as an alternative, this, in particular the extension of the FPC connector, enables the FPC connector, in particular, to be able to have space for the overcurrent protection fuses. This enables improved protection of the rechargeable battery pack.

In particular, the term “battery pack” may be used synonymously for the term “rechargeable battery pack”.

The rechargeable battery pack may be mobile or portable.

Mobile may mean a mass of at most 50 kg (kilograms), in particular at most 20 kg, in particular at most 10 kg, in particular at most 5 kg, and/or at least 0.2 kg, in particular at least 0.5 kg, in particular at least 1 kg, in particular at least 2 kg, in particular 0.8-1.9 kg.

The rechargeable battery pack and/or the rechargeable battery cells may be rechargeable.

The rechargeable battery cells may each be electrochemical-based individual rechargeable storage elements for electrical energy. In addition or as an alternative, the battery cells may be lithium-ion battery cells. Again in addition or as an alternative, the battery cells may be identical, in particular of the same type and/or construction. Again in addition or as an alternative, an, in particular respective, cell voltage, in particular cell rated voltage, of an, in particular respective, one of the rechargeable battery cells may be at least 2 V (volts) and/or at most 4 V, in particular 3.6 V.

The supply, detection, transmission and/or interruption may be automatic.

The term “configured”, “set up” or “intended” or the phrase “programmed to perform the function/s of” may be used synonymously for the term “designed”.

The term “comprises” may be used synonymously for the term “has” or “contains”.

The term “cell arrangement” may be used synonymously for the term “cell block”.

The cell block may be of parallelepipedal shape.

The battery management system may be electrical, in particular electronic, and/or have a measurement electronics device.

The term “measurement” may be used synonymously for the term “detection”.

The measurement signals may be temperatures and/or have values.

The cell voltages may be medium voltages and/or individual cell voltages.

The battery management system may be designed to determine states of charge, in particular individual states of charge, of the rechargeable battery cells.

The battery management system may not have the overcurrent protection fuses.

The battery management system and the FPC connector may be completely different.

The FPC connector may not be a cable harness and/or the rechargeable battery pack may not have a cable harness.

The term “flexible circuit board” or the term “conductor film” may be used synonymously for the term “FPC connector” (FPC short for flexible printed circuit).

The FPC connector may have an electrically insulating carrier that can carry at least the measurement conductor paths and the overcurrent protection fuses.

The measurement conductor paths may be electrically conductive and/or copper conductors.

The overcurrent protection fuses may be arranged, in particular electrically, in electrical measurement paths of the rechargeable battery pack and/or not in an electrical power path of the rechargeable battery pack for supplying the drive power to the piece of work equipment.

The battery management system may be designed in the case of or due to the interruption, to send an error message, in particular to the piece of work equipment.

The FPC connector may have, in particular exactly, one, in particular flexible, connector circuit board. The connector circuit board may be physically arranged with its connector plate plane on, in particular at, the block circumferential side parallel to the block circumferential side.

The term “runs” may be used synonymously for the phrase “extends”.

The term “outer side” may be used synonymously for the term “block circumferential side”.

The term “front side” may be used synonymously for the term “block front side”.

Reference is also made to the specialist literature.

In one development of the invention, the rechargeable battery cells are, in particular elongate, round cells. The round cells each have cell terminals on their opposite cell front sides. In particular, the round cells are physically arranged in at least one common cell plane with their longitudinal cell axes parallel to one another. In particular, the round cells are physically arranged with their longitudinal cell axes parallel to the block circumferential side. In particular, the component of the term “contact” may be used synonymously for the component of the term “terminal”. In addition or as an alternative, the cell terminals may be physically arranged along the extent, in particular from the first end to the second end.

In one development of the invention, the rechargeable battery pack has at least one cell holder. At least the cell holder holds the rechargeable battery cells. The cell block, in particular its cuboid shape, is formed by at least the cell holder, and in particular the held rechargeable battery cells. In particular, the term “defined” can be used synonymously for the term “formed”. In addition or as an alternative, the battery management system may be secured to the cell holder. In particular, it may be secured mechanically.

In one development of the invention, the FPC connector continuously extends from the block circumferential side to the second block front side, and in particular a second block circumferential side of the cell block, and/or in particular from on the first block front side to the first block circumferential side. The second block circumferential side is located opposite the first block circumferential side. This enables a simple design of the rechargeable battery pack with few components. In particular, the term “in one piece” or the phrase “without a physical interruption” can be used synonymously for the term “continuously”. In addition or as an alternative, the connector circuit board may be physically arranged with its connector plate plane on, in particular at, the second block front side parallel to the second block front side and/or on, in particular at, the second block circumferential side parallel to the second block circumferential side and/or on, in particular at, the first block front side parallel to the first block front side.

In one development of the invention, the battery management system is physically arranged, in particular completely and/or precisely, on, in particular at, the first block front side. In particular, the battery management system has at least, in particular precisely, one, in particular rigid, system circuit board. The system circuit board is physically arranged with its system board plane parallel to the first block front side. This enables a space-saving design of the rechargeable battery pack. In particular, the term “inflexible” can be used synonymously for the term “rigid”. In addition or as an alternative, at least the measurement conductor paths can extend up to the battery management system.

In one development of the invention, the FPC connector is secured to the battery management system. In particular, at least the measurement conductor paths are each soldered to the battery management system. This enables simple production and/or a good design of the rechargeable battery pack.

In one development of the invention, the battery pack has electrical cell connectors, in particular cell connector plates. The cell connectors electrically connect the rechargeable battery cells to one another in series and/or in parallel. The FPC connector is secured to each of the cell connectors. In particular, the measurement conductor paths are each connected, in particular in each case, in a materially bonded manner, in particular welded, in particular resistance-welded, to the cell connectors. This enables a good design of the rechargeable battery pack. In particular, the term “interconnected” can be used synonymously for the term “connected”. In addition or as an alternative, the cell connectors may be physically arranged along the extent, in particular from the first end to the second end. Again in addition or as an alternative, the cell connectors can be secured to at least the cell holder. Again in addition or as an alternative, the FPC connector can be secured to each of the cell connectors at least, in particular precisely, on the first block circumference side. Again in addition or as an alternative, in each case one overcurrent protection fuse of the overcurrent protection fuses can be arranged, in particular electrically, between the battery management system and each cell connector of the cell connectors. Again in addition or as an alternative, the measurement conductor paths can each extend up to the cell contactors.

In one development of the invention, the overcurrent protection fuses are conductor track fuses formed by at least the or integrally formed with at least the measurement conductor paths. This enables a simple design of the rechargeable battery pack with few components.

In one embodiment of the invention, at least the conductor path fuses, in particular in each case, have no taper, in particular no change in width and/or thickness, and/or no meandering structure. In other words: The conductor path fuses are over the entire length, in particular at least, of the measurement conductor paths. This enables simple production or manufacturing and/or robustness of the conductor path fuses.

In one development of the invention, at least the measurement conductor paths, in particular the conductor path fuses and/or each, have a width of at least 50 μm (micrometre), in particular at least 150 μm, and/or at most 500 μm, in particular 300 μm, and/or a thickness of at least 18 μm, in particular at least 35 μm, and/or at most 150 μm, in particular 70 μm, and/or the length of at least 5 mm (millimetre), in particular at least 10 mm. In addition or as an alternative, the overcurrent protection fuses, in particular each, have an interruption current value. The interruption current value is at most 25 A (amperes), in particular at most 12.5 A. In addition or as an alternative, the interruption current value is lower than a rated current value of the drive power. In particular, the interruption current value is less than 50%, in particular less than 25%, of the rated current value. In particular, the interruption current value may be predefined or predetermined or specified or fixed and/or greater than zero. In addition or as an alternative, the overcurrent protection fuses, in particular each, may be designed for interruption at the interruption current value.

In one development of the invention, an overcurrent protection fuse of the overcurrent protection fuses is designed for interrupting a measurement conductor path of the measurement conductor paths or a measurement connection of the measurement connections at the ground reference potential. This enables an increase in robustness of the rechargeable battery pack. In particular, the term “earth reference potential” can be used synonymously for the term “ground reference potential”. In addition or as an alternative, the overcurrent protection fuse may be arranged, in particular electrically, in an electrical ground path of the rechargeable battery pack.

In one development of the invention, the battery management system is designed to send data to the piece of work equipment and/or to receive data from the piece of work equipment. The rechargeable battery pack, in particular the FPC connector, has at least one electrical pack data contact, in particular a plug connector. The pack data contact is designed to touch an electrical equipment data contact of the piece of work equipment. The FPC connector comprises at least one electrical data conductor path. At least the data conductor path provides at least one electrical data connection between the battery management system and the pack data contact. At least the data conductor path is designed to transmit the data, in particular to send and/or receive the data. In other words: By means of at least the data conductor path, the battery management system and the pack data contact comprise at least the data connection to one another for the transmission of the data. This enables a multifunction of the FPC connector. In particular, the battery management system may have a data transmission device. In addition or as an alternative, the sending, reception and/or transmission may be automatic. Again in addition or as an alternative, the data relating to the supply of the drive power to the piece of work equipment may be the measurement signals and/or the states of charge and/or have values. Again in addition or as an alternative, the pack data contact may be secured to the cell holder. Again in addition or as an alternative, the pack data contact may be physically arranged, in particular completely and/or accurately, on, in particular at, the second block front side. Again in addition or as an alternative, an overcurrent protection fuse of the overcurrent protection fuses can be arranged, in particular electrically, between the battery management system and the pack data contact. Again in addition or as an alternative, the data conductor path can extend up to the battery management system and/or up to the pack data contact. Again in addition or as an alternative, the carrier can carry the pack data contact and/or the data conductor path. Again in addition or as an alternative, the data conductor path may be electrically conductive, a copper conductor path and/or designed like the measurement conductor paths. In particular, an overcurrent protection fuse of the overcurrent protection fuses may be designed to interrupt the data conductor path or the data connection in order to protect the battery management system against an electrical overcurrent. In particular, the overcurrent protection fuse may be conductor path fuse, in particular of the conductor path fuses, integrally formed by the data conductor path fuse. Again in addition or as an alternative, the term “contact” may be used synonymously for the term “touch”.

In one development, in particular one embodiment, of the invention, the FPC connector has a connector aperture, in particular a connector hole. The connector aperture is designed to have cooling air of the rechargeable battery cells flow through it, in particular past the rechargeable battery cells, or to have cooling air flow over it, in particular for air-cooling of the rechargeable battery cells. At least one measurement conductor path of the measurement conductor paths and/or the data conductor path extend/extends at least to the connector aperture. This enables the formation or generation of an air duct. In particular, the term “connector opening” can be used synonymously for the term “connector hole”. In addition or as an alternative, the connector aperture may be physically arranged, in particular completely and/or accurately, on, in particular at, the second block front side.

In one development of the invention, at least the measurement conductor paths between each other, in particular in each case, have a minimum gap of at most 2 mm, in particular at most 500 μm, in particular 300 μm. In addition or as an alternative, the FPC connector has a minimum width of at most 10 mm, in particular 3.5 mm. This enables a space-saving design of the rechargeable battery pack. In particular, the minimum gap may be at least 50 μm, in particular at least 100 μm, in particular at least 150 μm. In addition or as an alternative, the FPC connector may have a maximum width of at most 100 mm, in particular 47 mm.

The system according to the invention comprises the rechargeable battery pack as previously mentioned and comprises an, in particular the, piece of work equipment and/or an electric charger. The charger is designed to supply electrical charging power to the rechargeable battery pack. In particular, the system, the piece of work equipment and/or the charger may be mobile. In addition or as an alternative, the piece of work equipment may have a work tool and/or an, in particular electric, drive motor, in particular for driving the work tool. In particular, the drive power may be for the drive motor. Again in addition or as an alternative, the piece of work equipment may be ground-guided and/or hand-operated, in particular hand-held, and/or a piece of gardening, forestry, construction and/or cultivation work equipment. In particular, the piece of work equipment may be a saw, in particular a chainsaw, or a pruner, or a hedge trimmer, or a hedge cutter, or a wood cutter, or pruning shears, or an angle grinder or a blower, or a leaf blower, or a vacuum cleaner, or a leaf vacuum, or a cleaning appliance, or a high-pressure cleaner, or a sweeper, or a sweeper roller, or a sweeping brush, or a lawnmower, or a grass trimmer, or a brush cutter, or a scarifier. Again in addition or as an alternative, the rechargeable battery pack and the piece of work equipment may be designed for electrical and/or mechanical connection to one another in a manner releasable in particular without the use of tools and/or non-destructively, in particular by way of a user. Again in addition or as an alternative, the rechargeable battery pack and the piece of work equipment and/or the charger may be designed to carry the rechargeable battery pack by way of the piece of work equipment and/or the charger and/or to remove and/or replace the rechargeable battery pack. In particular, the piece of work equipment and/or the charger may have a rechargeable battery slot which may be designed for receiving the rechargeable battery pack. Again in addition or as an alternative, the supply may be automatic.

In other words: the overcurrent protection fuses limit a current consumption of the battery management system. If the current consumption of the battery management system reaches or exceeds the interruption current value or the specified limit value in the event of a fault, the overcurrent protection fuse(s) is (are) triggered and interrupt(s)/prevent(s) the continuation of the current flow, which can lead to further subsequent faults. In particular, operation with the piece of work equipment and/or the charger may no longer be possible after the overcurrent protection fuse has been triggered, in particular despite the intact power path. In addition or as an alternative, the fault event or the fault can be identified by the battery management system and displayed to the user or a customer.

Further advantages and aspects of the invention will become apparent from the claims and from the description of exemplary embodiments of the invention, which are explained below with reference to the figures.

### BRIEF DESCRIPTION OF THE DRAWINGS

FIG. 1 shows a perspective view of a rechargeable battery pack according to the invention for supplying electrical drive power to an electrically driven piece of work equipment without a pack housing,

FIG. 2 shows a view of a first block circumferential side of a cell block of the rechargeable battery pack,

FIG. 3 shows a view of an outer side or top side of a battery management system and an FPC connector of the rechargeable battery pack,

FIG. 4 shows a view of an inner side or bottom side of the battery management system and the FPC connector of the rechargeable battery pack, wherein the inner side is located opposite the outer side,

FIG. 5 shows another view of the inner side of the FPC connector,

FIG. 6 shows a perspective view of the rechargeable battery pack without the battery management system and without the FPC connector,

FIG. 7 shows a view of the first block circumferential side of the cell block without the battery management system and without the FPC connector,

FIG. 8 shows a perspective view of electrical cell connectors of the rechargeable battery pack,

FIG. 9 shows a view of the securing of the FPC connector to a cell connector of the cell connectors,

FIG. 10 shows a perspective view of a cell holder of the rechargeable battery pack,

FIG. 11 shows a perspective view of a contact plate of the rechargeable battery pack,

FIG. 12 shows a view of a second block circumferential side of the cell block with a housing cover of the pack housing,

FIG. 13 shows a view of a second block front side of the cell block,

FIG. 14 shows a sectional view of the rechargeable battery pack with a housing container of the pack housing,

FIG. 15 shows a view of the second block front side of the cell block without a part of the housing container,

FIG. 16 shows a view of the second block front side of the cell block with the pack housing or a second housing front side of the pack housing,

FIG. 17 shows a view of a first housing front side of the pack housing, wherein the first housing front side is located opposite the second housing front side,

FIG. 18 shows a view of a first housing circumferential side of the pack housing,

FIGS. 19 to 21 show at least one view of at least one other housing circumferential side of the pack housing, and

FIG. 22 shows a schematic view of a system according to the invention comprising the rechargeable battery pack, the piece of work equipment and an electric charger for supplying electrical charging power to the rechargeable battery pack.

### DETAILED DESCRIPTION OF THE EXEMPLARY EMBODIMENTS

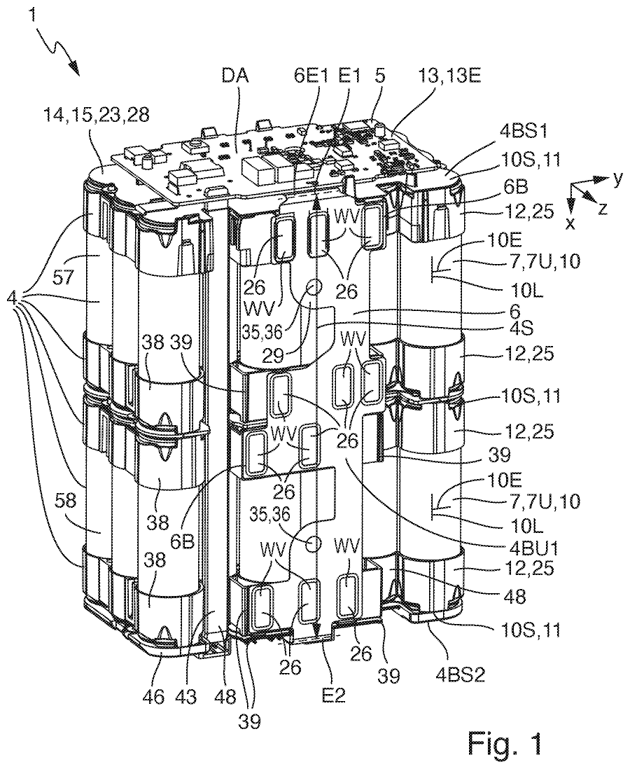

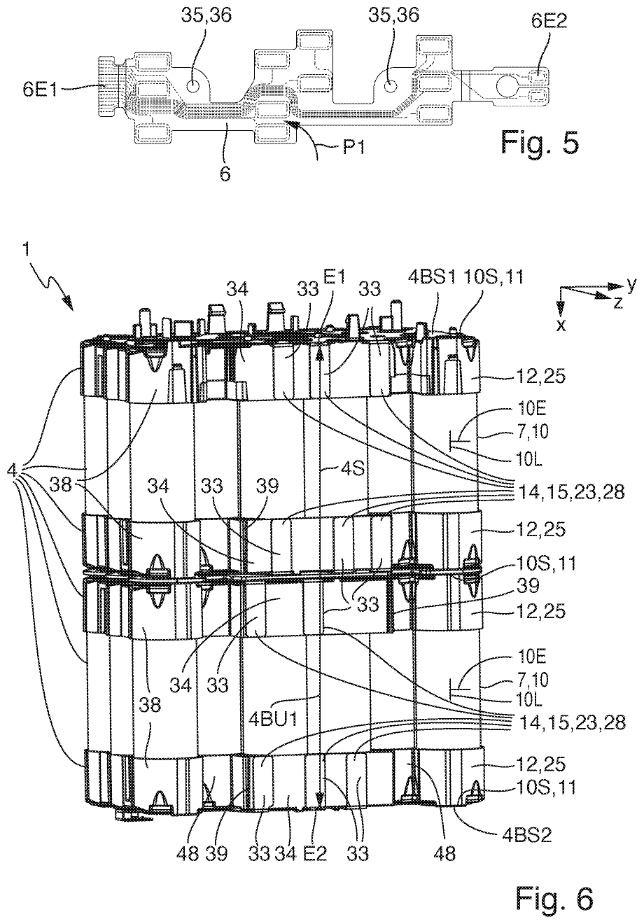

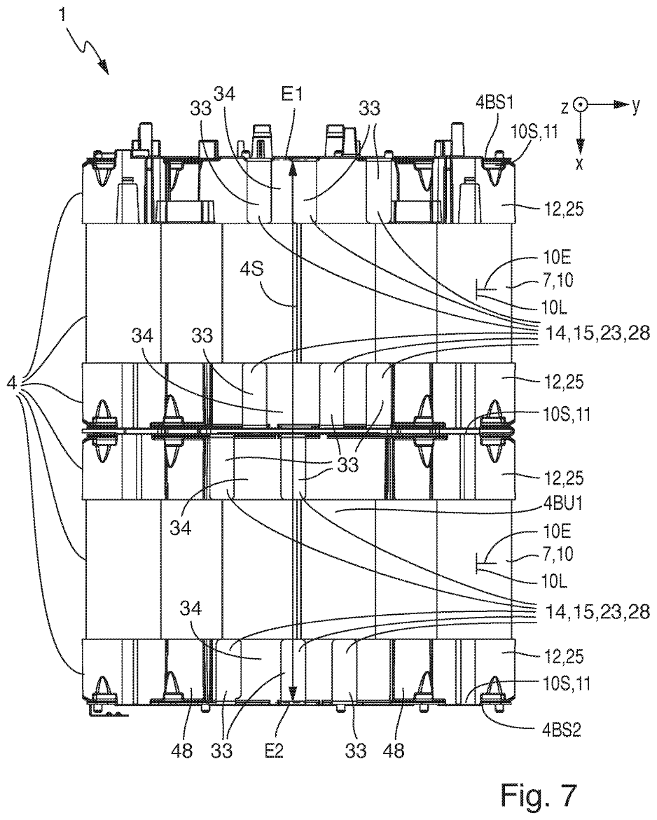

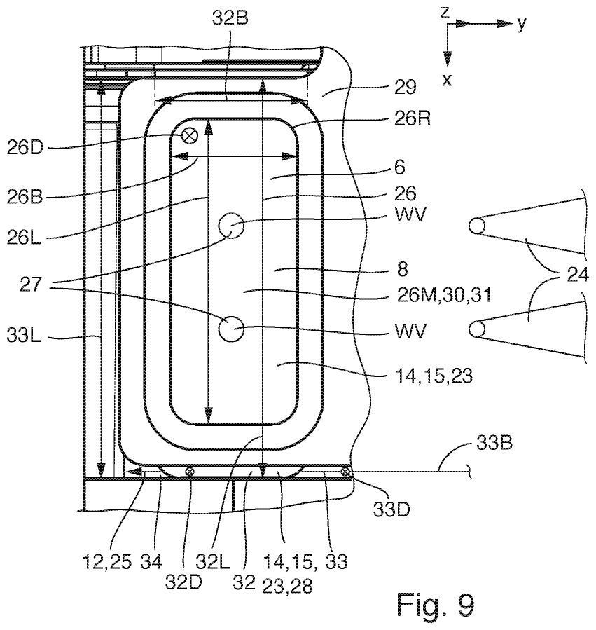

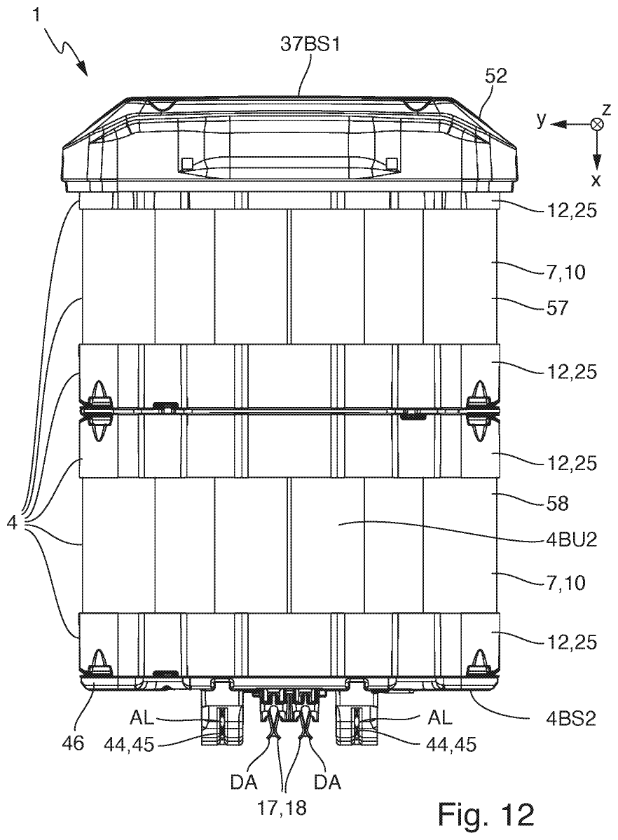

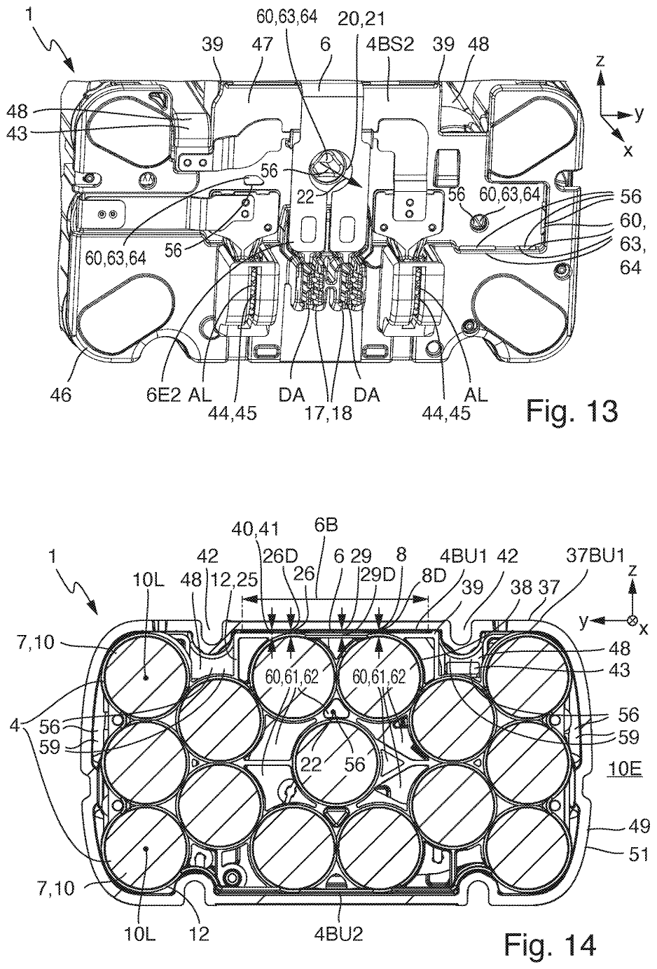

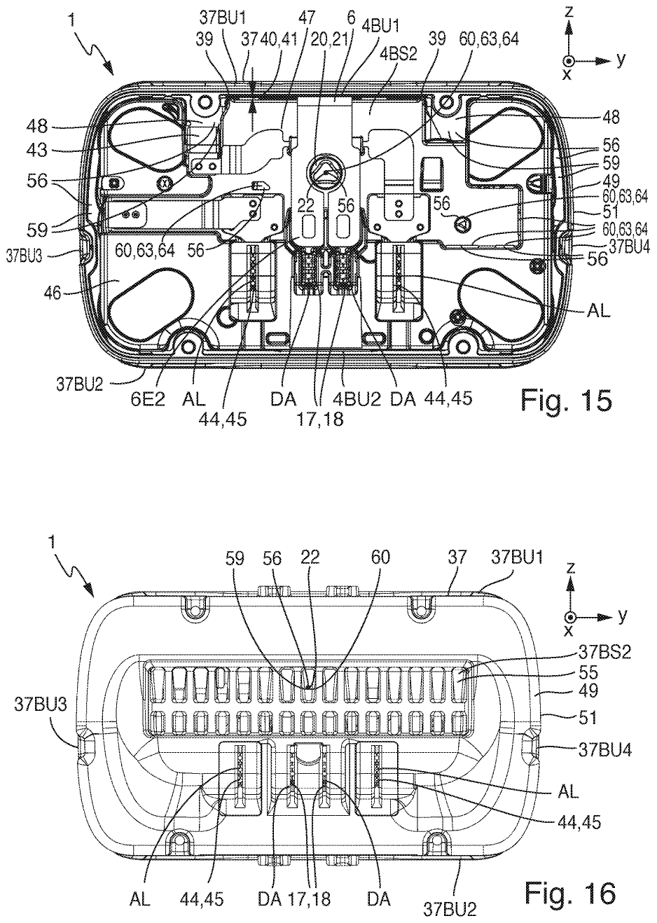

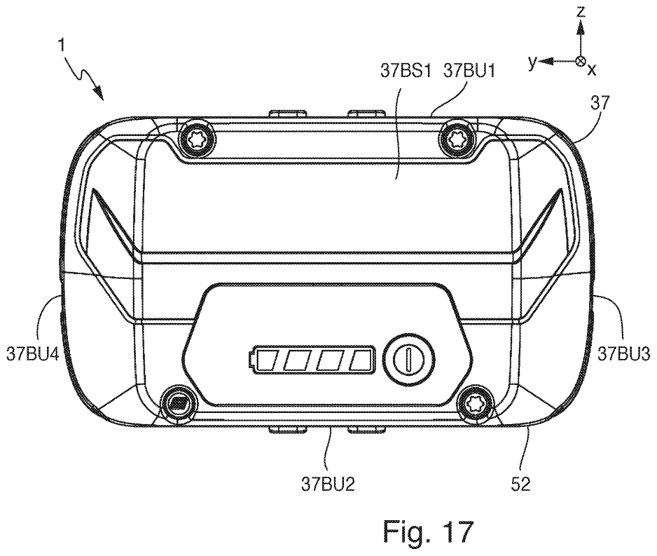

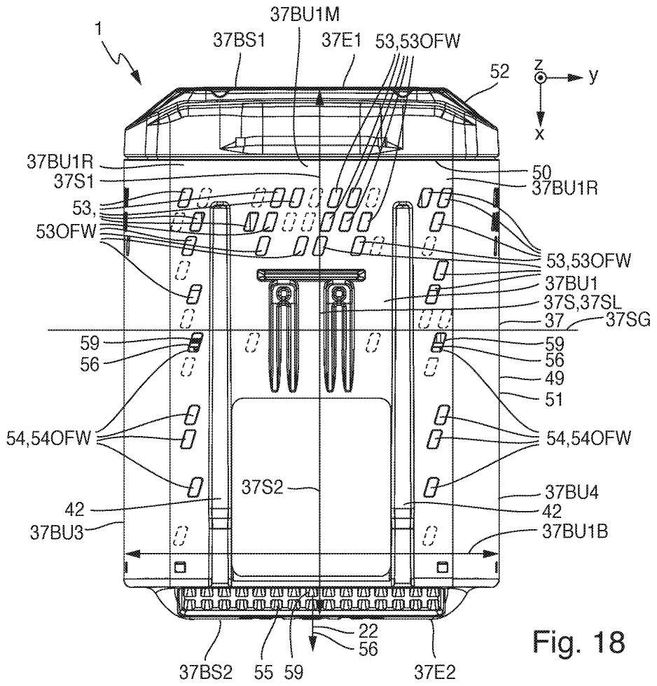

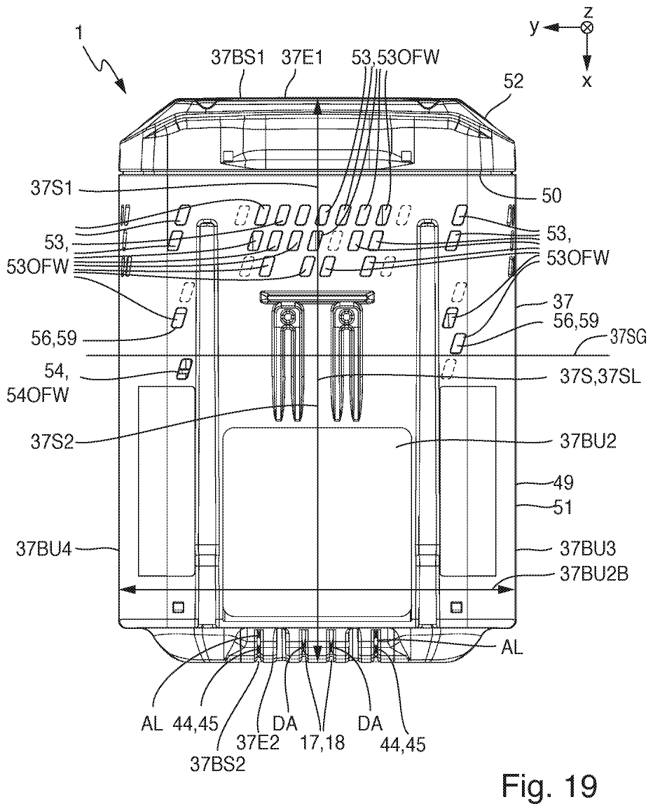

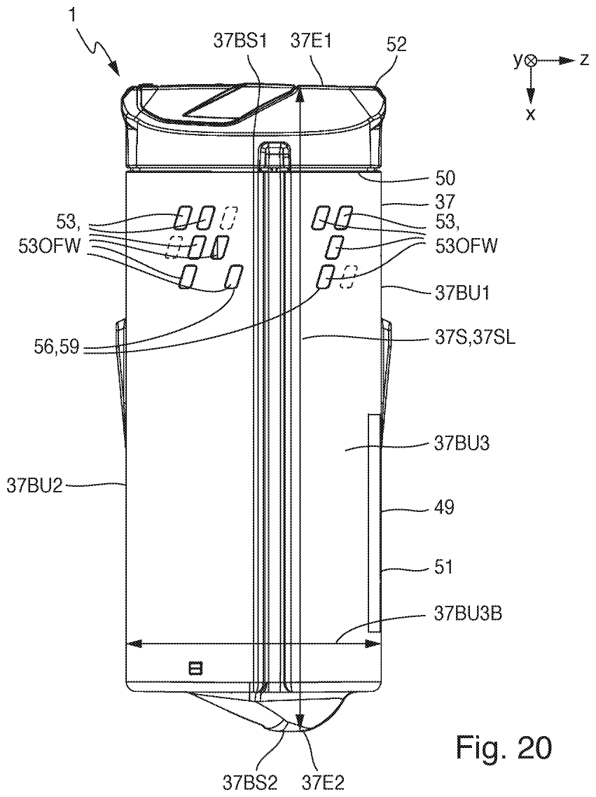

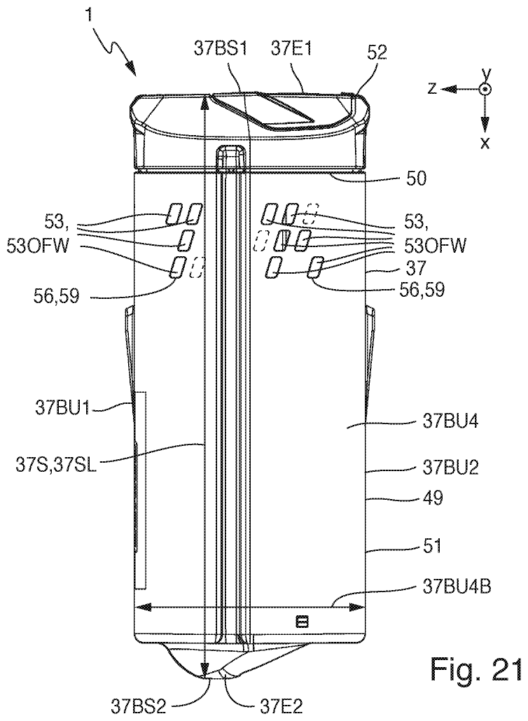

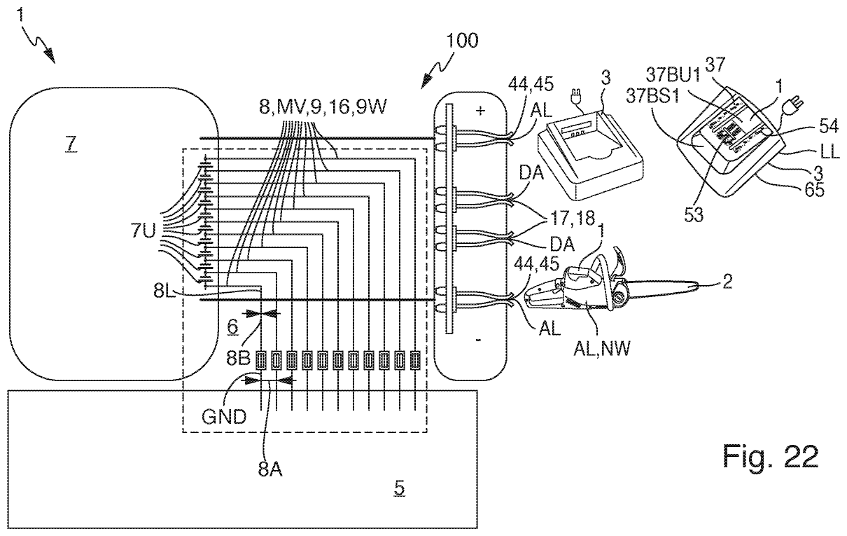

FIGS. 1, 2, 6, 7, 9 and 12 to 22 show a rechargeable battery pack 1 according to the invention. The rechargeable battery pack 1 is designed to supply, in particular supplies, electrical drive power AL to an electrically driven piece of work equipment 2, as shown in FIG. 22. The rechargeable battery pack 1 comprises an, in particular cuboid, cell block 4, a battery management system 5 and an FPC connector 6, as shown in FIGS. 1 to 7, 9, 12 to 15 and 22. The cell block 4 comprises rechargeable battery cells 7. The battery management system 5 is designed to detect the electrical measurement signals 7U, in particular cell voltages, of the rechargeable battery cells 7. The FPC connector 6 comprises at least electrical measurement conductor paths 8. At least the measurement conductor paths 8 provide at least electrical measurement connections MV of the battery management system 5 to the rechargeable battery cells 7. At least the measurement conductor paths 8 are designed to transmit, in particular transmit, at least the measurement signals 7U. The FPC connector 6 comprises electrical overcurrent protection fuses 9. The overcurrent protection fuses 9 are designed to interrupt at least the measurement conductor paths 8, in particular in each case, for protecting the battery management system 5 against an electrical overcurrent. The FPC connector 6 extends at least on a first block circumferential side 4BU1 of the cell block 4 over more than 50%, in particular over 100%, of an extent 4S from a first end E1 of the block circumferential side 4BU1 to a second end E2 of the block circumferential side 4BU1. The circumferential side of the block 4BU1 adjoins a first front side of the block 4BS1 of the cell block 4. The circumferential side of the block 4BU1 adjoins a second front side of the block 4BS2 of the cell block 4. The second block front 4BS2 side is located opposite the first block front side 4BS1.

FIG. 22 shows a system 100 according to the invention. The system 100 comprises the rechargeable battery pack 1 and comprises an, in particular the, piece of work equipment 2 and/or an electric charger 3. The charger 3 is designed to supply, in particular supplies, electrical charging power LL to the rechargeable battery pack 1.

In detail, the rechargeable battery cells 7 are, in particular elongate, round cells 10, as shown in FIGS. 1, 2, 6, 7 and 12 to 14. The round cells 10 each have cell terminals 11 on their opposite cell front sides 10S. In particular, the round cells 10 by way of their longitudinal cell axes 10L are physically arranged parallel to one another in at least one common cell plane 10E. In particular, the round cells 10 by way of their longitudinal cell axes 10L are physically arranged parallel to the block circumferential side 4BU1.

In the exemplary embodiment shown, the round cells 10 by way of their longitudinal cell axes 10L are physically arranged parallel to one another in exactly two common cell planes 10E. In alternative exemplary embodiments, the round cells with their longitudinal cell axes can be physically arranged parallel to one another in exactly one common cell plane or in at least three common cell planes.

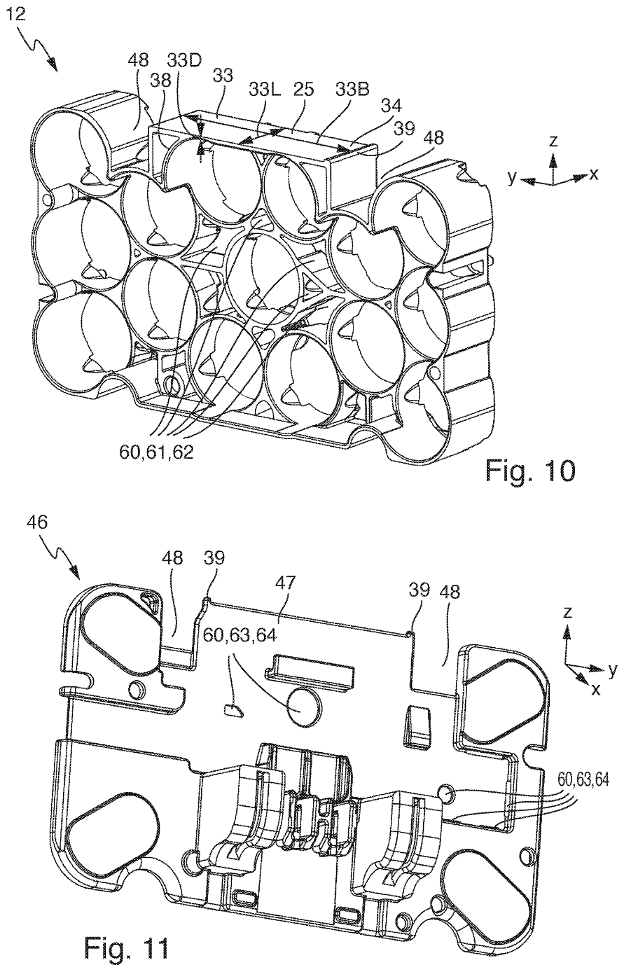

Furthermore, the rechargeable battery pack 1 has at least one cell holder 12, as shown in FIGS. 1, 2, 6, 7, 9, 10 and 12. At least the cell holder 12 holds the rechargeable battery cells 7. The cell block 4, in particular its cuboid shape, is formed by at least the cell holder 12, and in particular the held rechargeable battery cells 7.

In the exemplary embodiment shown, the rechargeable battery pack 1 has exactly four cell holders 12. In alternative exemplary embodiments, the rechargeable battery pack may have exactly one, exactly two, exactly three or at least five cell holders.

In addition, the FPC connector 6 continuously extends from the block circumference side 4BU1 to the second block front side 4BS2, and in particular in alternative exemplary embodiments a second block circumferential side 4BU2 of the cell block 4, and/or in particular from on the first block front side 4BS1 to the first block circumferential side 4BU1, as shown in FIGS. 1, 2, 14 and 15. The second block circumferential side 4BU2 is located opposite the first block circumferential side 4BU1.

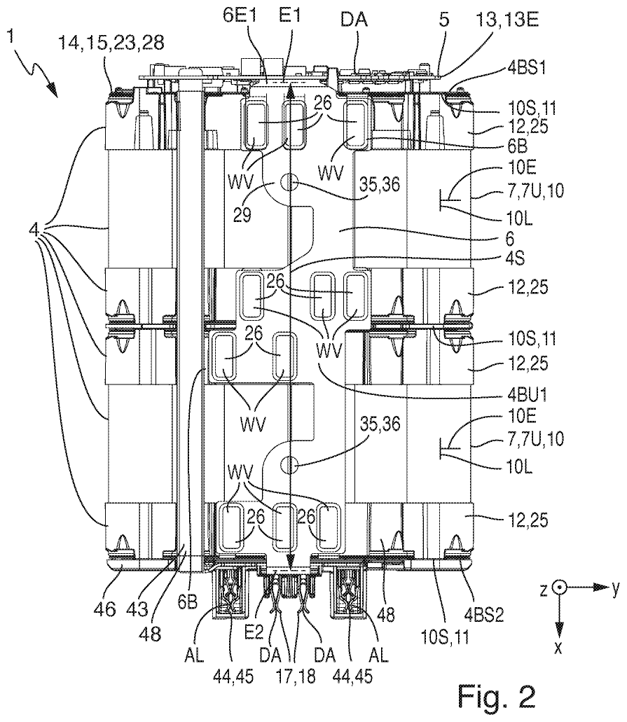

Furthermore, the battery management system 5 is physically arranged on the first block front side 4BS1, as shown in FIGS. 1 and 2. In particular, the battery management system 5 has at least one, in particular rigid, system circuit board 13. The system circuit board 13 is physically arranged with its system board plane 13E parallel to the first block front side 4BS1.

In addition, the FPC connector 6 is secured to the battery management system 5, as shown in FIGS. 1 to 4. In particular, at least the measurement conductor paths 8 are each soldered to the battery management system 5.

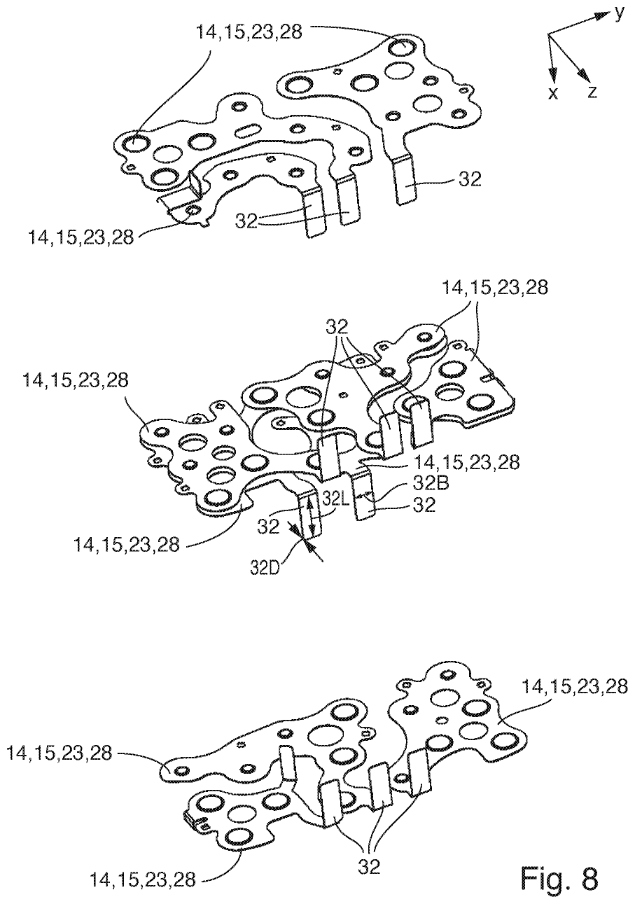

Furthermore, the rechargeable battery pack 1 has electrical cell connectors 14, in particular cell connector plates 15, as shown in FIGS. 1, 2 and 6 to 9. The cell connectors 14 electrically connect the rechargeable battery cells 7 to one another in series and/or in parallel. The FPC connector 6 is secured to each of the cell connectors 14. In particular, the measurement conductor paths 8 are each connected in a materially bonded manner, in particular resistance-welded, to the cell connectors 14.

In the exemplary embodiment shown, the FPC connector 6 has eleven measurement conductor paths 8 and/or the rechargeable battery pack 1 has, in particular correspondingly, in particular equally, eleven cell connectors 14. In alternative exemplary embodiments, the FPC connector may have fewer or more than eleven measurement conductor paths and/or the rechargeable battery pack may, in particular correspondingly, in particular equally, have fewer or more than eleven cell connectors.

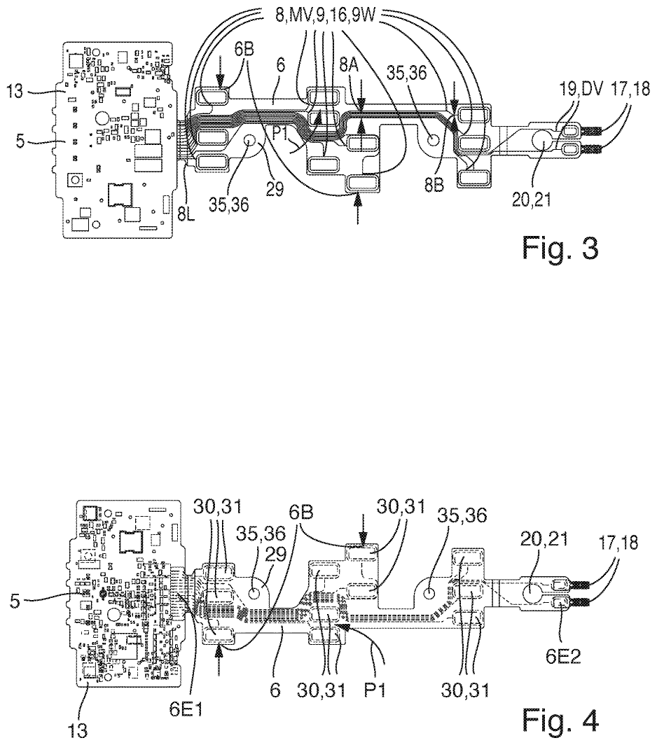

In addition, the overcurrent protection fuses 9 are conductor path fuses 16 integrally formed by at least the measurement conductor paths 8, as shown in FIGS. 3 and 22.

In detail, at least the conductor path fuses 16 have no taper, in particular no change in width and/or thickness, and/or no meandering structure.

Furthermore, at least the measurement conductor paths 8, in particular the conductor path fuses 16, have a width 8B of at least 50 μm, in particular at least 150 μm, and/or at most 500 μm, in particular 300 μm, and/or a thickness 8D of at least 18 μm, in particular at least 35 μm, and/or at most 150 μm, in particular 70 μm, and/or a length 8L of at least 5 mm, in particular at least 10 mm, as shown in FIGS. 3, 14 and 22. In addition or as an alternative, the overcurrent protection fuses 9 have an interruption current value 9 W. The interruption current value 9 W is at most 25 A, in particular at most 12.5 A. In addition or as an alternative, the interruption current value 9 W is lower than a rated current value NW of the drive power AL. In particular, the interruption current value 9 W is less than 50%, in particular less than 25%, of the rated current value NW.

In addition, an overcurrent protection fuse 9 of the overcurrent protection fuses 9 is designed for interrupting a measurement conductor path 8 of the measurement conductor paths 8 at on a ground reference potential GND, as shown in FIG. 22.

Furthermore, the battery management system 5 is designed to send data DA to the piece of work equipment 2 and/or to receive data DA from the piece of work equipment 2, in particular sends and/or receives, as shown in FIGS. 1, 2, 12, 13, 15, 16, 19 and 22. The rechargeable battery pack 1, in particular the FPC connector 6, comprises at least one electrical pack data contact 17, in particular a plug connector 18, as shown in FIGS. 2 to 4, 12, 13, 15, 16, 19 and 22. The pack data contact 17 is designed to touch, in particular touches, an electrical equipment data contact of the piece of work equipment 2. The FPC connector 6 has at least one electrical data conductor path 19, as shown in FIG. 3. At least the data conductor path 19 provides at least one electrical data connection DV between the battery management system 5 and the pack data contact 17. At least the data conductor path 19 is designed to transmit, in particular transmits, the data DA.

In the exemplary embodiment shown, the rechargeable battery pack 1 has exactly two pack data contacts 17 and/or the FPC connector 6 has, in particular correspondingly, in particular equally, exactly two data conductor paths 19. In alternative exemplary embodiments, the rechargeable battery pack may have exactly one pack data contact or at least three pack data contacts and/or the FPC connector may have, correspondingly, in particular equally, exactly one data conductor path or at least three data conductor paths.

In addition, the FPC connector 6 has a connector aperture 20, in particular a connector hole 21, as shown in FIGS. 3 to 5, 13 and 15. The connector aperture 20 is designed to have cooling air 22 of the rechargeable battery cells 7 flow through it, in particular has the cooling air flow through, as shown in FIGS. 14, 16 and 18. At least one measurement conductor path of the measurement conductor paths and/or the data conductor path 19 extend/extends at least to the connector aperture 20.

In the exemplary embodiment shown, the pack data contacts 17 at the connector aperture 20 are separated from each other (the connector aperture 20 has in principle an opening towards the pack data contacts 17). Thus, the pack data contacts 17 are more movable, which in turn provides a small tolerance compensation, which is advantageous with regard to the arrangement or the attachment of the pack data contacts 17 (the FPC connector 6 does not bulge).

Furthermore, at least the measurement conductor paths 8 have between one another a minimum gap 8A of at most 2 mm, in particular at most 500 μm, in particular 300 μm, as shown in FIGS. 3 and 22. In addition or as an alternative, the FPC connector 6 has a minimum width 6B of at most 10 mm, in particular 3.5 mm, as shown in FIGS. 1 to 4 and 14.

In addition, a rated, in particular electrical, voltage of the rechargeable battery pack 1 is at least 10 V, in particular at least 18 V, and/or at most 100 V, in particular at most 72 V, in particular 36 V.

In addition or as an alternative, the, in particular maximum, drive power AL and/or the, in particular maximum, charging power LL, in particular a continuous power or peak power, is at least 10 watts (W), in particular at least 100 W, in particular at least 1 kW (kilowatt), in particular at least 2 kW, and/or at most 10 kW, in particular at most 5 kW, in particular at most 4 kW, in particular 3 kW.

Again in addition or as an alternative, a maximum, in particular electrical, rated energy content of the battery pack 1 is at least 10 Wh (watt hours), in particular at least 100 Wh, in particular at least 200 Wh, and/or at most 4000 Wh, in particular at most 2000 Wh, in particular at most 1000 Wh, in particular at most 500 Wh, in particular 340 Wh.

Again in addition or as an alternative, the rechargeable battery pack 1 has a height or a thickness, in particular in the direction z, of at least 2.5 centimetres (cm) and/or at most 10 cm, in particular 5 cm, and/or a width, in particular in the direction y, of at least 5 cm and/or at most 20 cm, in particular 10 cm, and/or a depth or length, particularly in the direction x, of at least 7.5 cm and/or at most 30 cm, in particular 15 cm.

As the exemplary embodiments shown and explained above make clear, the invention provides an advantageous rechargeable battery pack for supplying electrical drive power to an electrically driven piece of work equipment and an advantageous system comprising the rechargeable battery pack, which have improved properties.

Furthermore, in addition to the claims mentioned below under “What is Claimed is”, additional or alternative claims may be:
1. Rechargeable battery pack (1) for supplying electrical drive power (AL) to an electrically driven piece of work equipment (2),
   wherein the rechargeable battery pack (1) has rechargeable battery cells (7), electrical cell contactors (23) and an FPC connector (6),
   wherein the cell contactors (23) are electrically connected to the rechargeable battery cells (7), and
   wherein the FPC connector (6) is electrically connected to the cell contactors (23) in each case by means of resistance welding joints (WV) by means of welding electrodes (24) from above produced,
characterized
   in that the rechargeable battery pack (1) has at least one cell holder (12), wherein at least the cell holder (12) holds the rechargeable battery cells (7), wherein at least the cell holder (12) is formed as at least one welding support (25) for producing the resistance welding joints (WV), and wherein at least the cell holder (12) is arranged physically below the cell contactor (23) and the FPC connector (6), and/or
   in that the FPC connector (6) has electrically conductive connector welding surfaces (26), wherein the connector welding surfaces (26) each extend continuously between welding points (27) of the resistance welding joints (WV) with a respective cell contactor (23) of the cell contactors (23), in particular wherein the cell contactors (23) are physically arranged below the connector welding surfaces (26) to produce the resistance welding joints (WV).
2. Rechargeable battery pack (1) according to claim 1,
   wherein the rechargeable battery pack (1) has a battery management system (5), which is designed to detect electrical measurement signals (7U), in particular cell voltages, of the rechargeable battery cells (7), and
   wherein the FPC connector (6) comprises at least electrical measurement conductor paths (8),
   wherein at least the measurement conductor paths (8) and the cell contactors (23) provide at least electrical measurement connections (MV) of the battery management system (5) to the rechargeable battery cells (7), and
   wherein at least the measurement conductor paths (8) and the cell contactors (23) are designed to transmit at least the measurement signals (7U).
3. Rechargeable battery pack (1) according to Claim 1 or 2,
   wherein the cell contactors (23) are electrical cell connectors (14) which electrically connect the rechargeable battery cells (7) to one another in series and/or in parallel.
4. Rechargeable battery pack (1) according to any one of Claims 1 to 3,
   wherein the cell contactors (23) are rigid, in particular cell contact plates (28).
5. Rechargeable battery pack (1) according to any one of Claims 1 to 4,
   wherein the cell holder (12) formed as the welding support (25) continuously extends below at least two cell contactors (23) of the cell contactors (23), and
   wherein the FPC connector (6) does not extend continuously above or below the two cell contactors (23).
6. Rechargeable battery pack (1) according to any one of Claims 1 to 5,
   wherein the FPC connector (6) has an electrically insulating carrier (29) which carries the connector welding surfaces (26) at their edges (26R) and has apertures (30), in particular windows (31), below or above their centres (26M) designed for producing the resistance welding joints (WV), and
   wherein the cell contactors (23) are physically arranged below the connector welding surfaces (26) to produce the resistance welding joints (WV).
7. Rechargeable battery pack (1) according to any one of Claims 1 to 6,
   wherein the connector welding surfaces (26) for producing the resistance welding joints (WV) have a thickness (26D) of at least 150 μm and in particular at least 18 μm, particular at least 35 μm, in particular 70 μm, and/or a width (26B) of at least 1.5 mm and/or at most 10 mm, in particular 4 mm, and/or a length (26L) of at least 2 mm and/or at most 30 mm, in particular 12 mm, and/or
   wherein electrically conductive contactor welding surfaces (32) of the cell contactors (23) for producing the resistance welding joints (WV) have a thickness (32D) of more than 150 μm, and in particular at most 750 μm, in particular 300 μm, and/or a width (32B) of at least 3 mm and/or at most 15 mm, in particular 6 mm, and/or a length (32L) of at least 8 mm and/or at most 30 mm, in particular 16 mm, and/or
   wherein electrically insulating support surfaces (33) of the at least one welding support (25) for producing the resistance welding joints (WV) have a thickness (33D) of more than 150 μm, and in particular at most 3 mm, in particular 0.9 mm, and/or a width (33B) of at most 43 mm.
8. Rechargeable battery pack (1) according to any one of Claims 1 to 7,
   wherein electrically insulating support surfaces (33) of the at least one welding support (25), in particular at least one wall (34) of at least the cell holder (12), each continuously extend below the resistance welding joints (WV) more than between the welding points (27), in particular wherein a length (33L) of the support surfaces (33) is at least as large as a length (26L, 32L) of the connector welding surfaces (26) and/or electrically conductive contactor welding surfaces (32) of the cell contactors (23) for producing the resistance welding joints (WV), and in particular wherein a width (33B) of the support surfaces (33) is at least as large as a width (26B, 32B) of the connector welding surfaces (26) and/or the contactor welding surfaces (32).
9. Rechargeable battery pack (1) according to any one of Claims 1 to 8,
   wherein the cell contactors (23) have electrically conductive contactor welding surfaces (32) for producing the resistance welding joints (WV) which each continuously extend below the resistance welding joints (WV) at least between the respective connector welding surface (26) of the connector welding surfaces (26), in particular wherein a length (32L) of the contactor welding surfaces (32) is at least as large as a length (26L) of the connector welding surfaces (26), and in particular wherein a width (32B) of the contactor welding surfaces (32) is at least as large as a width (26B) of the connector welding surfaces (26).
10. Rechargeable battery pack (1) according to any one of Claims 1 to 9,
   wherein the FPC connector (6) has at least one aperture (35), in particular a through-hole (36), at least which is designed to receive a positioning and/or orientation device for positioning and/or for orientation of the FPC connector (6) with respect to the cell contactors (23) for producing the resistance welding joints (WV).
11. Rechargeable battery pack (1) according to any one of Claims 1 to 10,
   wherein the FPC connector (6) is of elongate design and is secured by means of its longitudinal ends (6E1, 6E2), in particular to produce the resistance welding joints (WV), between which the resistance welding joints (WV) are physically arranged,
   in particular wherein the FPC connector (6) is secured by way of its first longitudinal end (6E1) by means of a battery management system (5) of the rechargeable battery pack (1), and/or in particular wherein the FPC connector (6) is secured by way of its second longitudinal end (6E2) by means of at least one electrical pack data contact (17) of the rechargeable battery pack (1), in particular of the FPC connector (6).
12. Rechargeable battery pack (1) according to any one of Claims 1 to 11,
   wherein the rechargeable battery pack (1) comprises an, in particular cuboid, cell block (4) which comprises the rechargeable battery cells (7), and
   wherein from above to below is in the direction (-z) of the cell block (4), and/or wherein the connector welding surfaces (26) are physically arranged at least, in particular precisely, on a block side (4BU1) of the cell block (4) parallel to the block side (4BU1), in particular a block circumferential side (4BU1).
13. Rechargeable battery pack (1) according to any one of Claims 1 to 12,
   wherein the rechargeable battery pack (1) has a pack housing (37), wherein the rechargeable battery cells (7), the cell contactors (23), the FPC connector (6) and at least the cell holder (12) are physically arranged in the pack housing (37), and
   wherein at least the cell holder (12) has at least one holding part (38), wherein at least the holding part (38) holds the rechargeable battery cells (7), and wherein at least the cell holder (12) has at least one spacer projection (39) such that the pack housing (37), together with the at least one holding part (38), forms a gap (40), wherein the FPC connector (6) is physically arranged in at least one connector space (41) created by means of the gap (40).
14. Rechargeable battery pack (1) according to any one of Claims 1 to 13,
   wherein the rechargeable battery pack (1) has a pack housing (37), wherein the rechargeable battery cells (7), the cell contactors (23) and the FPC connector (6) are physically arranged in the pack housing (37), and wherein the pack housing (37) has guide grooves (42) which running side by side are designed to guide the rechargeable battery pack (1) for mechanical connection with the piece of work equipment (2), wherein the FPC connector (6) is physically arranged between the guide grooves (42) and not next to the guide grooves (42).
15. System (100) comprising:
   a rechargeable battery pack (1) according to any one of Claims 1 to 14, and
   a piece of work equipment (2) and/or an electric charger (3) designed to supply electrical charging power (LL) to the rechargeable battery pack (1).

Furthermore, in addition to the claims mentioned below under “What is Claimed is”, additional or alternative claims may be:
1. Rechargeable battery pack (1) for supplying electrical drive power (AL) to an electrically driven piece of work equipment (2),
   wherein the rechargeable battery pack (1) has rechargeable battery cells (7), an FPC connector (6) and a pack housing (37),
   wherein the FPC connector (6) is electrically connected to the rechargeable battery cells (7), and
   wherein the rechargeable battery cells (7) and the FPC connector (6) are physically arranged in the pack housing (37),
characterized
   in that the pack housing (37) has guide grooves (42) which running side by side are designed to guide the rechargeable battery pack (1) for mechanical connection with the piece of work equipment (2), wherein the FPC connector (6) is physically arranged between the guide grooves (42) and not next to the guide grooves (42), and/or
   in that the rechargeable battery pack (1) has at least one cell holder (12), wherein at least the cell holder (12) is physically arranged in the pack housing (37), wherein at least the cell holder (12) has at least one holding part (38), wherein at least the holding part (38) holds the rechargeable battery cells (7), and wherein at least the cell holder (12) has at least one spacer projection (39) such that the pack housing (37), together with the at least one holding part (38), forms a gap (40), wherein the FPC connector (6) is physically arranged in at least one connector space (41) created by means of the gap (40).
2. Rechargeable battery pack (1) according to Claim 1,
   wherein the rechargeable battery pack (1) has a power rail (43), wherein the power rail (43) is designed to transmit the drive power (AL), wherein the power rail (43) is physically arranged in the pack housing (37), and wherein the power rail (43) runs next to the FPC connector (6) and/or below a guide groove (42) of the guide grooves (42).
3. Rechargeable battery pack (1) according to Claim 1 or 2,
   wherein the rechargeable battery pack (1) has at least one electrical pack power contact (44), in particular a plug connector (45), wherein the pack power contact (44) is designed to touch an electrical equipment power contact of the piece of work equipment (2) for transmitting the drive power (AL), and/or wherein the rechargeable battery pack (1), in particular the FPC connector (6), has at least one electrical pack data contact (17), in particular a plug connector (18), wherein the pack data contact (17) is designed to touch an electrical equipment data contact of the piece of work equipment (2) for transmitting data (DA) between the rechargeable battery pack (1) and the piece of work equipment (2), and
   wherein the rechargeable battery pack (1) has a contact plate (46), wherein the contact plate (46) is physically arranged in the pack housing (37), wherein the contact plate (46) has a carrier part (47), wherein the carrier part (47) carries the pack power contact (44) and/or the pack data contact (17), and wherein the contact plate (46) has at least one spacer projection (39) such that the pack housing (37), together with the carrier part (47), forms the gap (40).
4. Rechargeable battery pack (1) according to any one of Claims 1, 2 or 3,
   wherein at least the cell holder (12), and in particular the contact plate (46), has notches (48) in which the guide grooves (42), and in particular the power rail (43), are physically arranged.
5. Rechargeable battery pack (1) according to any one of Claims 1 to 4,
   wherein at least the spacer projection (39) and/or the connector space (41) are physically arranged between the guide grooves (42) and not next to the guide grooves (42), and/or
   wherein the FPC connector (6) and/or the connector space (41) is/are physically arranged between spacer projections (39) and not next to the spacer projections (39).
6. Rechargeable battery pack (1) according to any one of Claims 1 to 5,
   wherein the pack housing (37) has a housing container (49) which has an insertion opening (50) through which the rechargeable battery cells (7), the FPC connector (6) and at least the cell holder (12) are inserted into the housing container (49), wherein at least the cell holder (12) comprises at least the spacer projection (39) such that a container wall (51) of the housing container (49), together with the at least one holding part (38), forms the gap (40),
   in particular wherein the pack housing (37) has a housing cover (52) which closes the insertion opening (50) of the housing container (49).
7. Rechargeable battery pack (1) according to any one of Claims 1 to 6,
   wherein the rechargeable battery pack (1) has an, in particular cuboid, cell block (4), wherein the cell block (4) comprises the rechargeable battery cells (7), and wherein the cell block (4) is physically arranged in the pack housing (37), and
   wherein the FPC connector (6) and the guide grooves (42) are physically arranged on a block side (4BU1), in particular a block circumferential side (4BU1), of the cell block (4) parallel to the block side (4BU1),
   in particular wherein the cell block (4), in particular the cuboid shape thereof, is formed by at least the cell holder (12), in particular at least the holding part (38), and in particular the held rechargeable battery cells (7).
8. Rechargeable battery pack (1) according to any one of Claims 1 to 7,
   wherein the rechargeable battery pack (1) has electrical cell contactors (23), in particular cell contactor plates (28), wherein the cell contactors (23) are physically arranged in the pack housing (37), and wherein the cell contactors (23) are electrically connected to the rechargeable battery cells (7),
   wherein the FPC connector (6) is electrically connected to the cell contactors (23) in each case by means of resistance welding joints (WV), and
   wherein the resistance welding joints (WV) are physically arranged between the guide grooves (42) and not next to the guide grooves (42), and in particular on the block side (4BU1) of the cell block (4) parallel to the block side (4BU1).
9. Rechargeable battery pack (1) according to any one of Claims 1 to 8,
   wherein the rechargeable battery pack (1) has electrical cell contactors (23), in particular cell contactor plates (28), wherein the cell contactors (23) are physically arranged in the pack housing (37), and wherein the cell contactors (23) are electrically connected to the rechargeable battery cells (7),
   wherein the FPC connector (6) is electrically connected to the cell contactors (23) in each case by means of resistance welding joints (WV) by means of welding electrodes (24) from above produced,
   wherein at least the cell holder (12), in particular at least the holding part (38), is formed as at least one welding support (25) for producing the resistance welding joints (WV), and wherein at least the cell holder (12) is arranged physically below the cell contactor (23) and the FPC connector (6), and
   wherein at least the spacer projection (39) is physically arranged above the at least one welding support (25) and/or next to the FPC connector (6).
10. Rechargeable battery pack (1) according to any one of Claims 1 to 9,
   wherein the FPC connector (6) is of elongate design and is secured by means of its longitudinal ends (6E1, 6E2), in particular to produce the resistance welding joints (WV), in particular between which the resistance welding joints (WV) are physically arranged,
   in particular wherein the FPC connector (6) is secured by way of its first longitudinal end (6E1) by means of a battery management system (5) of the rechargeable battery pack (1), and/or in particular wherein the FPC connector (6) is secured by way of its second longitudinal end (6E2) by means of at least one electrical pack data contact (17) of the rechargeable battery pack (1), in particular of the FPC connector (6).
11. Rechargeable battery pack (1) according to any one of Claims 1 to 10,
   wherein the rechargeable battery pack (1) has an, in particular cuboid, cell block (4), wherein the cell block (4) comprises the rechargeable battery cells (7), and wherein the cell block (4) is physically arranged in the pack housing (37), and
   wherein the FPC connector (6) extends at least on a first block circumferential side (4BU1) of the cell block (4) over more than 50%, in particular over 100%, of an extent (4S) from a first end (E1) of the block circumferential side (4BU1), which adjoins a first block front side (4BS1) of the cell block (4), to a second end (E2) of the block circumferential side (4BU1), which adjoins a second block front side (4BS2) of the cell block (4), wherein the second block front side (4BS2) is located opposite the first block front side (4BS1),
   in particular wherein the FPC connector (6) extends continuously from the block circumferential side (4BU1) to the second block front side (4BS2), and in particular a second block circumferential side (4BU2) of the cell block (4), wherein the second block circumferential side (4BU2) is located opposite the first block circumferential side (4BU1), and/or in particular from the first block front side (4BS1) to the first block circumferential side (4BU1),
   in particular wherein the cell block (4), in particular the cuboid shape thereof, is formed by at least the cell holder (12), in particular at least the holding part (38), and in particular the held rechargeable battery cells (7).
12. Rechargeable battery pack (1) according to any one of Claims 1 to 11,
   wherein the rechargeable battery pack (1) has a battery management system (5), wherein the battery management system (5) is designed to detect electrical measurement signals (7U), in particular cell voltages, of the rechargeable battery cells (7), and wherein the battery management system (5) is physically arranged in the pack housing (37), and
   wherein the FPC connector (6) comprises at least electrical measurement conductor paths (8),
   wherein at least the measurement conductor paths (8) provide at least electrical measurement connections (MV) of the battery management system (5) to the rechargeable battery cells (7), and
   wherein at least the measurement conductor paths (8) are designed to transmit at least the measurement signals (7U).
13. Rechargeable battery pack (1) according to any one of Claims 1 to 12,
   wherein the FPC connector (6) has an electrically insulating carrier (29) which has a thickness (29D) of at most 500 μm, and in particular at least 50 μm, in particular 200 μm.
14. System (100) comprising:
   a rechargeable battery pack (1) according to any one of Claims 1 to 13, and
   a piece of work equipment (2) and/or an electric charger (3) designed to supply electrical charging power (LL) to the rechargeable battery pack (1).

In addition to the claims mentioned under “What is Claimed is”, additional or alternative claims may be:
1. Rechargeable battery pack (1) for supplying electrical drive power (AL) to an electrically driven piece of work equipment (2),
   wherein the rechargeable battery pack (1) has rechargeable battery cells (7) and a block-shaped, in particular cuboid, pack housing (37),
   wherein the rechargeable battery cells (7) are physically arranged in the pack housing (37),
   wherein the pack housing (37) has, on at least a first circumferential side of the housing (37BU1), first air inlet openings (53) along a first half (37S1) of a extent (37S) and second air inlet openings (54) along a second half (37S2) of the extent (37S) and on a, in particular exactly one, second housing front side (37BS2) air outlet openings (55) for air flow (56) in the pack housing (37) from the first air inlet openings (53) and the second air inlet openings (54) in each case past the rechargeable battery cells (7) to the air outlet openings (55) for air cooling of the rechargeable battery cells (7),
   wherein the extent (37S) is from a first end (37E1) of the housing circumferential side (37BU1), which adjoins a first housing front side (37BS1) of the pack housing (37), to a second end (37E2) of the housing circumferential side (37BU1), which adjoins the second housing front side (37BS2) of the pack housing (37), wherein the second housing front side (37BS2) is located opposite the first housing front side (37BU1),
   wherein the first half (37S1) adjoins the first housing front side (37BS1),
   wherein the second half (37S2) adjoins the second housing front side (37BS2), and
   wherein a ratio (53OFW/54OFW) of first opening surface values (53OFW) of the first air inlet openings (53) to the second opening surface values (54OFW) of the second air inlet openings (54) is in a value range of 2, in particular 5, to 20, in particular up to 15, in particular 8.
2. Rechargeable battery pack (1) according to Claim 1,
   wherein the first air inlet openings (53) and the second air inlet openings (54) are physically arranged and wherein the ratio (53OFW/54OFW) is such that the flow resistance values for the air flow (56) in the pack housing (37) from the first air inlet openings (53) and the second air inlet openings (54) past the rechargeable battery cells (7) to the air outlet openings (55) are identical in each case and/or that the air cooling of the rechargeable battery cells (7) is homogeneous.
3. Rechargeable battery pack (1) according to Claim 1 or 2,
   wherein the first air inlet openings (53) are distributed along the first half (37S1) over at least 50%, in particular 60%, of the first half (37S1) and/or physically arranged up to a boundary (37SG) with the second half (37S2), and/or
   wherein the second air inlet openings (54) are distributed along the second half (37S2) over at least 50%, in particular 60%, in particular 70%, of the second half (37S2) and/or physically arranged from the boundary (37SG) with the first half (37S1) onwards, and/or
   wherein the rechargeable battery cells (7) are distributed along the first half (37S1) over at least 50%, in particular 60%, in particular 70%, of the first half (37S1) and/or physically arranged up to the boundary (37SG) with the second half (37S2), and/or
   wherein the rechargeable battery cells (7) are distributed along the second half (37S2) over at least 50%, in particular 60%, in particular 70%, in articular 80%, of the second half (37S2) and/or physically arranged from the boundary (37SG) with the first half (37S1) onwards.
4. Rechargeable battery pack (1) according to any one of Claims 1 to 3,
   wherein the rechargeable battery pack (1) has an, in particular cuboid, cell block (4), wherein the cell block (4) is physically arranged in the pack housing (37), and wherein the cell block (4) has a first sub-block (57) and a second sub-block (58), wherein the first sub-block (57) and the second sub-block (58) comprise the rechargeable battery cells (7) and are physically arranged sequentially along the extent (37S).
5. Rechargeable battery pack (1) according to any one of Claims 1 to 4,
   wherein at least 25%, in particular 33%, of the first air inlet openings (53) and/or at least 50%, in particular at least 65%, in particular at least 80%, of the second air inlet openings (54) are physically arranged on the first housing circumferential side (37BU1), wherein a width (37BU1B) orthogonal to the extent (37S) of the first housing circumferential side (37BU1) is at least as large as widths (37BU2B, 37BU3B, 37BU4B) of all further housing circumferential sides (37BU2, 37BU3, 37BU4) of the pack housing (37), in particular wherein a length (37SL) of the section (37S) is greater than all the widths (37BU1B, 37BU2B, 37BU3B, 37BU4B), and/or
   wherein the pack housing (37) has air inlet openings (53, 54) on at least one further housing circumferential side (37BU2, 37BU3, 37BU4), in particular all other housing circumferential sides (37BU2, 37BU3, 37BU4) of the pack housing (37).
6. Rechargeable battery pack (1) according to any one of Claims 1 to 5,
   wherein the first air inlet openings (53) are physically arranged along a width (37BU1B) orthogonal to the extent (37S) of the first housing circumferential side (37BU1) at edges (37BU1R) and in a centre (37BU1M) of the first housing circumference side (37BU1), and/or
   wherein the second air inlet openings (54) are physically arranged along the width (37BU1B) orthogonal to the extent (37S) of the first housing circumferential side (37BU1) at the edges (37BU1R) and not in the centre (37BU1M) of the first housing circumference side (37BU1).
7. Rechargeable battery pack (1) according to any one of Claims 1 to 6,
   wherein the rechargeable battery pack (1) comprises an, in particular cuboid, cell block (4), wherein the cell block (4) comprises the rechargeable battery cells (7), and
   wherein the pack housing (37) is formed and wherein the cell block (4) is formed and physically arranged in the pack housing (37) such that at least one air duct (59) between the pack housing (37) and the cell block (4), in particular the rechargeable battery cells (7), passes the cell block (4) at least partially along the extent (37S), in particular on at least the first housing circumferential side (37BU1), and in particular at least one further housing circumferential side (37BU2, 37BU3, 37BU4) of the pack housing (37), in particular all other housing circumferential sides (37BU2, 37BU3, 37BU4) of the pack housing (37), is formed for the air flow (56).
8. Rechargeable battery pack (1) according to any one of Claims 1 to 7,
   wherein the rechargeable battery pack (1) comprises an, in particular cuboid, cell block (4), wherein the cell block (4) comprises the rechargeable battery cells (7), and wherein the cell block (4) is formed and physically arranged in the pack housing (37) such that at least one air duct (60) is formed for the air flow (56) through the cell block (4) at least partially along the extent (37S), in particular up to the second housing front side (37BS2).
9. Rechargeable battery pack (1) according to Claim 8,
   wherein the rechargeable battery pack (1) has at least one cell holder (12), a contact plate (46) and/or an FPC connector (6), wherein at least the cell holder (12), the contact plate (46) and/or the FPC connector (6) is/are physically arranged in the pack housing (37) on the cell block (4) and/or on the second housing front side (37BS2), in particular parallel to the second housing front side (37BS2),
   wherein at least the cell holder (12) holds the rechargeable battery cells (7), and wherein the cell holder (12) has a holder aperture (61), in particular a holder hole (62), wherein the air duct (60) is formed through at least the holder aperture (61), and/or
   wherein the contact plate (46) carries at least one electrical pack power contact (44) and/or at least one electrical pack data contact (17) of the rechargeable battery pack (1), and wherein the contact plate (46) has a plate aperture (63), in particular a plate hole (64), wherein the air duct (60) is formed through at least the plate aperture (63), and/or
   wherein the FPC connector (6) has a connector aperture (20), in particular a connector hole (21), wherein the air duct (60) is formed through the at least one connector aperture (20), wherein at least one measurement conductor path and/or a data conductor path (19) of the FPC connector (6) extend/extends at least to the connector aperture (20).
10. Rechargeable battery pack (1) according to Claim 9,
   wherein the holder aperture (61), the plate aperture (63), the connector aperture (20) and the air outlet openings (55) are arranged sequentially along the extent (37S).
11. Rechargeable battery pack (1) according to any one of Claims 1 to 10,
   wherein the rechargeable battery pack (1) has at least one electrical pack power contact (44), in particular a plug connector (45), wherein the pack power contact (44) is designed to make contact with an electrical equipment power contact of the piece of work equipment (2) for transmitting the drive power (AL), and/or wherein the rechargeable battery pack (1) has at least one electrical pack data contact (17), in particular a plug connector (18), wherein the pack data contact (17) is designed to make contact with an electrical equipment data contact of the piece of work equipment (2) for transmitting data (DA) between the rechargeable battery pack (1) and the piece of work equipment (2), and
   wherein the pack power contact (44) and/or the pack data contact (17) are/is physically arranged on, in particular precisely, the second housing front side (37BS2), in particular further away from the first housing circumferential side (37BU1) than the air outlet openings (55).
12. Rechargeable battery pack (1) according to any one of Claims 1 to 11,
   wherein the rechargeable battery cells (7) are, in particular elongate, round cells (10), in particular wherein the round cells (10) are physically arranged with their longitudinal cell axes (10L) parallel to the extent (37S), and in particular parallel to one another in at least one common cell plane (10E).
13. Rechargeable battery pack (1) according to any one of Claims 1 to 12,
   wherein the pack housing (37) has a housing container (49) which has an insertion opening (50) through which the rechargeable battery cells (7) are inserted into the housing container (49), and
   wherein the pack housing (37) has a housing cover (52) which closes the insertion opening (50) of the housing container (49),
   wherein the housing container (49) and not the housing cover (52) comprises the first air inlet openings (53), the second air inlet openings (54) and the air outlet openings (55),
   in particular wherein the housing cover (52) and the housing container (49) are physically arranged sequentially along the extent (37S).
14. System (100) comprising:
   a rechargeable battery pack (1) according to any one of Claims 1 to 13, and
   a piece of work equipment (2) and/or an electric charger (3) designed to supply electrical charging power (LL) to the rechargeable battery pack (1).
15. System (100) according to Claim 14,
   wherein the piece of work equipment and/or the charger (3) and the rechargeable battery pack (1) are designed to receive the rechargeable battery pack (1) by way of the piece of work equipment and/or the charger (3) and wherein the piece of work equipment and/or the charger (3) have/has a fan (65) such that the fan (65) is designed to generate the air flow (56) in the pack housing (37), wherein the fan (65) is designed to suck cooling air (22) out of the air outlet openings (55) of the rechargeable battery pack (1) received by way of the piece of work equipment and/or the charger (3), and in particular such that the first air inlet openings (53) and the second air inlet openings (54) are free for suction into the first air inlet openings (53) and the second air inlet openings (54) on at least the first housing circumferential side (37BU1).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rechargeable battery pack for supplying electrical drive power to an electrically driven piece of work equipment, comprising:
a cell block;
a battery management system; and
an FPC connector,
wherein the cell block has rechargeable battery cells,
wherein the battery management system is designed to detect electrical measurement signals of the rechargeable battery cells,
wherein the FPC connector comprises electrical measurement conductor paths,
wherein the measurement conductor paths provide electrical measurement connections of the battery management system to the rechargeable battery cells,
wherein the measurement conductor paths are designed to transmit the measurement signals,
wherein the FPC connector has electrical overcurrent protection fuses which are designed to interrupt the measurement conductor paths to protect the battery management system against an electrical overcurrent, and
wherein the FPC connector extends on a first block circumferential side of the cell block over more than 50% of a distance from a first end of the first block circumferential side, which adjoins a first block front side of the cell block, to a second end of the block circumferential side, which adjoins a second block front side of the cell block,
wherein the second block front side is located opposite the first block front side.

2. The rechargeable battery pack according to claim 1,
wherein the FPC connector extends continuously from:
(i) the first block circumferential side to a second block circumferential side of the cell block, wherein the second block circumferential side is located opposite the first block circumferential side, and/or
(ii) the first block front side to the first block circumferential side.

3. The rechargeable battery pack according to claim 1,
wherein the battery management system is physically arranged on the first block front side,
wherein the battery management system has at least one system circuit board which is physically arranged with its system board plane parallel to the first block front side.

4. The rechargeable battery pack according to claim 1,
wherein the FPC connector is secured to the battery management system at least by the measurement conductor paths being each soldered to the battery management system.

5. The rechargeable battery pack according to claim 1, further comprising:
electrical cell connectors which electrically connect the rechargeable battery cells to one another in series and/or in parallel,
wherein the FPC connector is secured to each of the cell connectors at least by the measurement conductor paths being each connected in a materially bonded manner to the cell connectors.

6. The rechargeable battery pack according to claim 1,
wherein the overcurrent protection fuses are conductor path fuses which are integrally formed by the measurement conductor paths.

7. The rechargeable battery pack according to claim 6,
wherein the conductor path fuses have no taper.

8. The rechargeable battery pack according to claim 7,
wherein the conductor path fuses have no change in width and/or thickness and/or no meandering structure.

9. The rechargeable battery pack according to claim 1,
wherein the measurement conductor paths have a width of at least 50 μm and/or at most 500 μm, and/or a thickness of at least 18 μm and/or at most 150 μm, and/or a length of at least 5 mm, and/or
wherein the overcurrent protection fuses have an interruption current value, wherein the interruption current value is at most 25 A, and/or wherein the interruption current value is lower than a rated current value of the drive power.

10. The rechargeable battery pack according to claim 1,
wherein one overcurrent protection fuse of the overcurrent protection fuses is formed for interrupting a measurement conductor path of the measurement conductor paths at a ground reference potential.

11. The rechargeable battery pack according to claim 1,
wherein the battery management system is designed to send data to the piece of work equipment and/or to receive data from the piece of work equipment,
wherein the rechargeable battery pack has at least one electrical pack data contact, which is designed to touch an electrical equipment data contact of the piece of work equipment,
wherein the FPC connector has at least one electrical data conductor path,
wherein the data conductor path provides an electrical data connection of the battery management system to the pack data contact, and
wherein the data conductor path is designed to transmit the data.

12. The rechargeable battery pack according to claim 1,
wherein the FPC connector has a connector aperture, which is designed to have cooling air of the rechargeable battery cells flow through the aperture,
wherein at least one measurement conductor path of the measurement conductor paths and/or a data conductor path extend/extends at least to the connector aperture.

13. The rechargeable battery pack according to claim 1,
wherein the measurement conductor paths have a minimum distance between one another of at most 2 mm, and/or
wherein the FPC connector has a minimum width of at most 10 mm.

14. A system, comprising:
the rechargeable battery pack according to claim 1; and
the piece of work equipment and/or an electric charger designed to supply electrical charging power to the rechargeable battery pack.
